(19) United States
(12) Patent Application Publication
(10) Pub. No.: US 2011/0277297 A1
(43) Pub. Date: Nov. 17, 2011

(54) Method and Tool for Installing and Removing Tracks on Vehicles

(76) Inventors: Kleiman Rich, Morristown, IN (US); Greg Sego, Boggstown, IN (US)

(21) Appl. No.: 12/947,036

(22) Filed: Nov. 16, 2010

Related U.S. Application Data
(60) Provisional application No. 61/261,469, filed on Nov. 16, 2009.

(51) Int. Cl. B23P 17/04; B23Q 3/00

(52) U.S. Cl. 29/428; 29/283

(57) ABSTRACT

A clamping arm tool for aligning the ends of a track over the wheels of a vehicle, allows the ends of the track to be pulled together for easy installation and removal of the bolts of the track. The clamping arm tool provides a quick, stable and controlled method for securing the ends of a track over the front and rear wheels of a vehicle.

### CROSS-REFERENCE TO COPENDING APPLICATION

This application claims the benefit of U.S. Provisional Application 61/261,469 entitled “Method and Tool for Installing and Removing Tracks on Vehicle” by Rich Kleiman and Greg Sego filed Nov. 16, 2009, the contents of which are herein incorporated by reference.

### FIELD OF THE INVENTION

This invention generally relates to installing and removing tracks over the wheels of vehicles including tractors, skid loaders and other vehicles and more particularly to methods and tools designed to simplify and speed the installation and removal of tracks on the wheels of vehicles.

### BACKGROUND OF THE INVENTION

Skid steer loaders, tractors and other utility vehicles are generally versatile machines; however, these vehicles often lose traction under various ground surfaces or conditions. For example, the addition of removable tracks on vehicles improves the traction of the vehicles on steep slopes, uneven, loose, frozen, wet or muddy conditions. It is well known to use removable, tracks wrapped around the front and rear vehicle tires to improve the traction of the vehicle for improved performance under adverse conditions.

Removable tracks are often made of steel or heavy duty materials to provide improved traction and increased wear resistance. The tracks are often very heavy (it is not uncommon for a single track to weigh over 1000 pounds) and very difficult to maneuver, making installation and removal of the tracks cumbersome and time consuming. The tracks are generally installed using ropes and ratcheting straps, making the installation and alignment of the tracks difficult and slow.

Prior art devices have done little to ease the installation or removal of the heavy and burdensome tracks. Furthermore, the structural limitations of the tracks often make repairs to vehicle more difficult.

Therefore, an object of the present invention is to provide a track installation tool and method that reduces the time required to install tracks over the wheels of various utility vehicles.

Another object of the invention is provide a track installation tool and method that allows the installation and removal of tracks over the wheels of various utility vehicles providing improved accuracy in tensioning and releasing the tracks allowing the installation bolts to be easily inserted or removed.

A further object of the invention is to provide a track installation tool that is stable and able to quickly secure the tracks in an operable position.

Still another object of the invention is to provide a track installation tool that is able to fit multiple types and styles of tracks.

Another object of the invention is to provide a track installation tool that is capable of tensioning and releasing tracks on a utility vehicle with minimal interference or congestion of the work area.

Therefore, it is desirable to provide a track installation tool and method that addresses the objects and problems described above.

### SUMMARY OF THE INVENTION

The preferred embodiment of the present invention is comprised of three grapple or clamping arms, one hydraulic cylinder, a cylinder bracket and a hand hydraulic pump. The clamping arms connect the tracks by pulling the opposite ends of the tracks together until the tracks are aligned. Once the tracks are aligned, the tracks are secured and the track clamping tool is removed.

### BRIEF DESCRIPTION OF THE DRAWING

FIG. 1 is a perspective of view of the clamping arm tool aligning tracks for assembly or disassembly on a wheeled vehicle.

FIG. 2 is an expanded view of the clamp arm tool.

FIG. 3 is a side view of the clamp arm tool.

FIG. 4 is a side view of the hand pump.

FIG. 5 is top view of the clamp arm tool.

FIG. 6 is a side view of the cylinder bracket.

FIG. 7 is a top view of the cylinder bracket.

FIG. 8 is a side view of a closed clamp arm tool.

FIG. 9 is a side view of an open clamp arm tool.

FIG. 10 is a side view of a second clamp arm tool in a closed state.

FIG. 11 is a side view of a second clamp arm tool in a partially open state.

FIG. 12 is a side view of a second clamp arm tool in a fully open state.

### DETAILED DESCRIPTION OF THE INVENTION

The present invention relates to a method and tool for installing and removing tracks on skid steers and other vehicles. The invention may be used with a wide variety of tracks for skid steers, tractors and other vehicles, but those of skill in the art will recognize that the present invention is equally adaptable for use with other wheeled vehicles where tracks are installed or removed from wheels for increased vehicle mobility. For descriptive purposes, the present invention will be described as used on a skid steer loader.

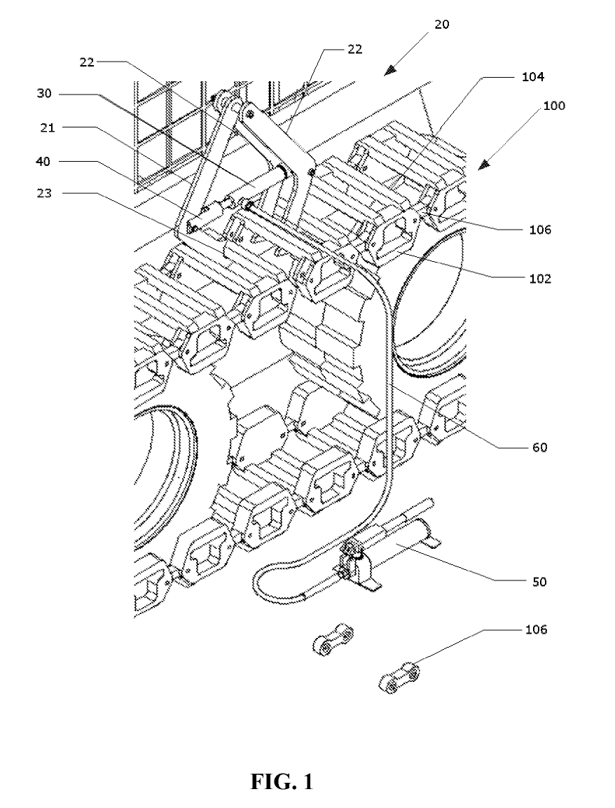

FIG. 1 shows a perspective view of the clamping arm tool assembly 20 pulling the opposite ends of a track 100 together so that the opposite ends of the track may be secured or removed from the vehicle's wheels. When the opposite ends of the track are joined together around the front and rear wheels of a skid steer or other utility vehicle, the ends of the track are secured by bolts or other means allowing the track to form an endless loop that encircles the front and rear wheels of the vehicle. The clamping arm tool 20 allows the ends of the track to be pulled together making alignment of the bolts or securing means for the tracks to be completed quickly and easily. The clamping arm tool 20 is placed above the track and the gripping areas 23 of the tool are positioned on each end of the track. The gripping area 23 at the bottom of clamping arm 21 secures one end of the track, while the gripping area 23 in the bottom section of clamping arms 22 secures the opposite end of the track. The hand pump 50 is used to activate the cylinder pump causing the clamping arms to pull the ends of the track together in a controlled movement. Once the ends of the tracks 100 are aligned, bolts or other securing means are secured allowing the track to form an endless loop around the front and rear wheels of the vehicle. With the track secured, the cylinder valve xx is opened and the clamping arms 22 and 21 release the ends of the track xx and the track clamping arm tool 20 is removed.

The clamping arm tool 20 includes two outside clamping arms 22, one middle clamping arm 21, one hydraulic cylinder 30, one cylinder bracket 40 and a hand pump 50. The clamping arm tool 20 simplifies and speeds the installation and removal of tracks from skid steers and utility vehicles.

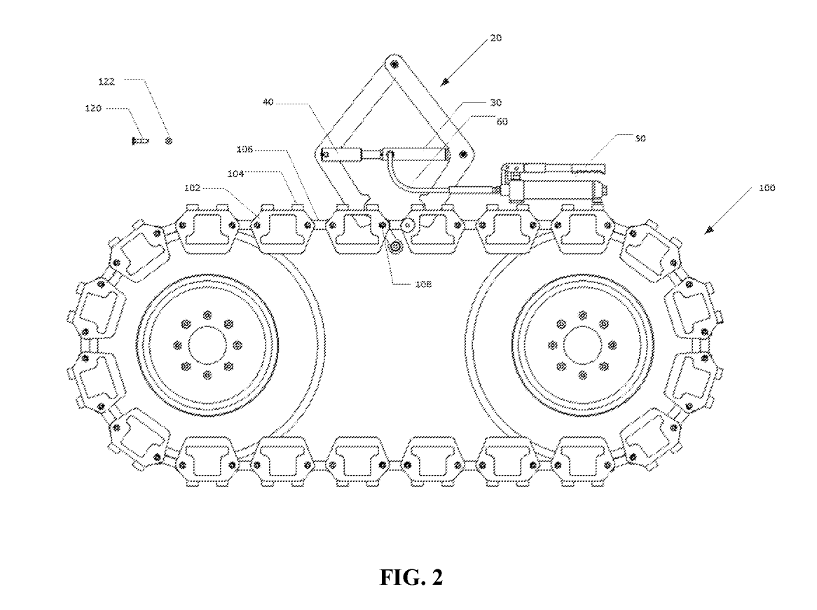

FIG. 2 shows an expanded view of the clamping arm tool 20 without the hand pump 50 or the hand pump connector line 60. The hand pump connector line 60 connects via quick release connectors to the hand pump 50 and the hydraulic cylinder at XX. As shown, the clamping arm tool 20 includes two exterior or outside clamp arms 22 and one interior or middle clamp arm 21. More or less than three clamp arms 22 and 21 can be used without departing from the spirit of the invention, however, two exterior clamp arms 22 with a single interior clamp arm 21 provides significant stability for aligning the tracks 100 while minimizing material costs.

FIG. 2 show the clamp arms 22 and 21 secured in the top section with a bolt 26, two clamp arm spacers 24, a washer 28 and a nut 29 allowing the clamp arms to form a diamond-like shape that is opened at the lower or bottom section for pulling the ends of the track 100 snug. The clamp arms 22 and 21 are also secured in the middle portion by a cylinder connector 46 and a hydraulic cylinder 30. The hydraulic cylinder 30 is secured to the two exterior clamping arms via clamp arm spacers 24 and 25 and a bolt 26, washer 28 and nut 29. The cylinder connector 40 secures to the middle or interior clamping arm 21 via a clamp arm pin 42, a washer 28 and a cotter pin 44. As one with ordinary skill in the art will recognize the clamping arms 22 and 21 and the power source may be secured by other means and methods, allowing the clamping arms 22 and 21 to rotate and create a closing action at the bottom section of the clamping arms 22 and 21 where the arms form a contact point or a curved gripping surface 23. One with ordinary skill in the art will recognize that the curved gripping surface 23 can be modified in shape, however, must provide a surface area capable of securing the ends of a track 100 as the ends are pulled together with significant force.

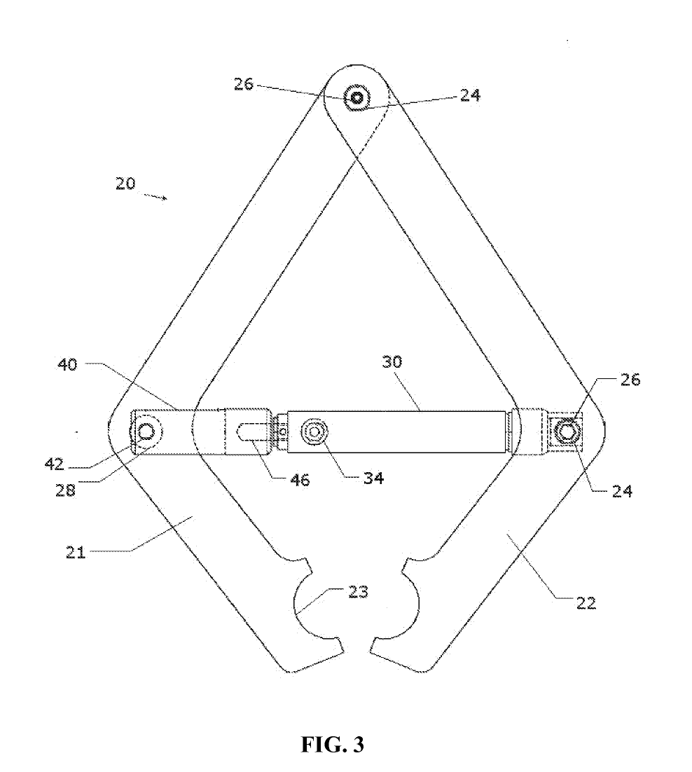

As shown in FIG. 3 each clamp arm 22 and 21 is generally shaped like a sideways “u” or “v”. The clamp arms 22 and 21 are made of steel and the clamp arm 22 or 21 must be strong enough to withstand the pressure of the power source and capable of pulling heavy duty tracks, which often weigh in excess of 1000 pounds, snug for easy securing or disassembly. In the preferred embodiment the clamping arms 21 and 22 are two and half inches wide and ½ inch thick. The bottom or lower section of the clamping arms 22 or 21 includes a gripping surface 23 to hold each end of the track 100 as the ends are pulled together to align and secure the tracks or to release the tension on the tracks so that the tracks may be disassembled with ease.

FIG. 3 shows three clamping arms 22 and 21. Two of the clamping arms 22 are secured to the hydraulic cylinder 30 and are located outside of the middle or interior clamping arm 21. The middle-clamping arm 21, is secured to the cylinder bracket 40 and is located in a plane inside the two outside clamping arms 22. The middle clamping arm 21 has a curved gripping area 23 that faces and aligns with the curved gripping area of the two outside clamping arms 22 which are aligned in an opposite orientation, facing the middle clamping arm 21.

FIG. 3 shows the hydraulic cylinder 30 connected to the cylinder bracket 40. The cylinder bracket receptor 46 connects with the cylinder connector 32. The connection between the hydraulic cylinder 30 and the cylinder bracket 40 is accomplished by removing the end of a standard hydraulic cylinder 30 and using a set screw to secure the hydraulic cylinder rod (which is threaded) to the cylinder bracket 40 at the cylinder bracket receptor 46.

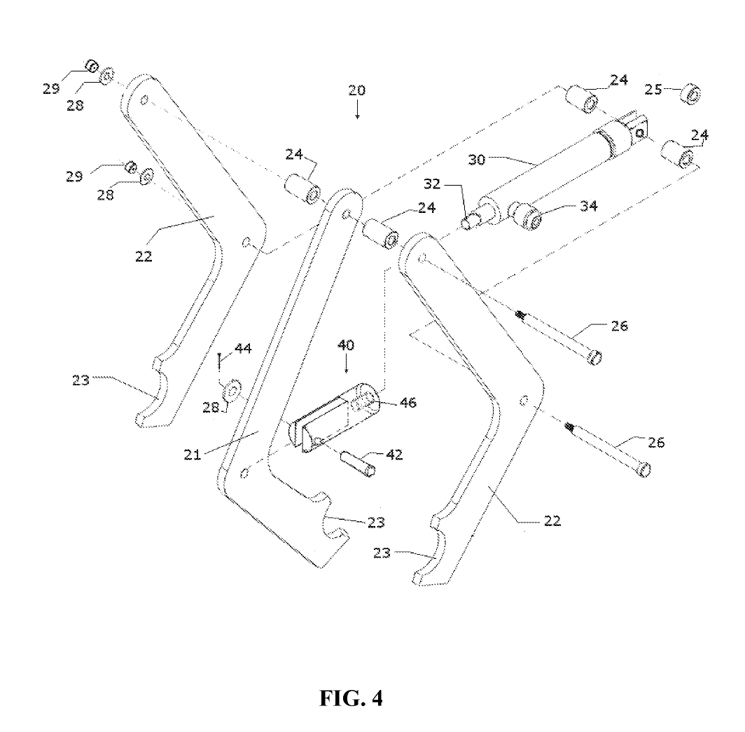

FIG. 4 shows a top view of the cylinder bracket 40. The cylinder bracket 40 is a customized part that includes a center groove XX that receives the middle-clamping arm 21. The cylinder bracket 40 is secured to the middles clamping arm 21 by a clamp arm pin 42, a washer 28 and a cotter pin 44. The cylinder bracket 40 is secured to the hydraulic cylinder 30 allowing a clamping action between the opposing clamp arms 22 and 21.

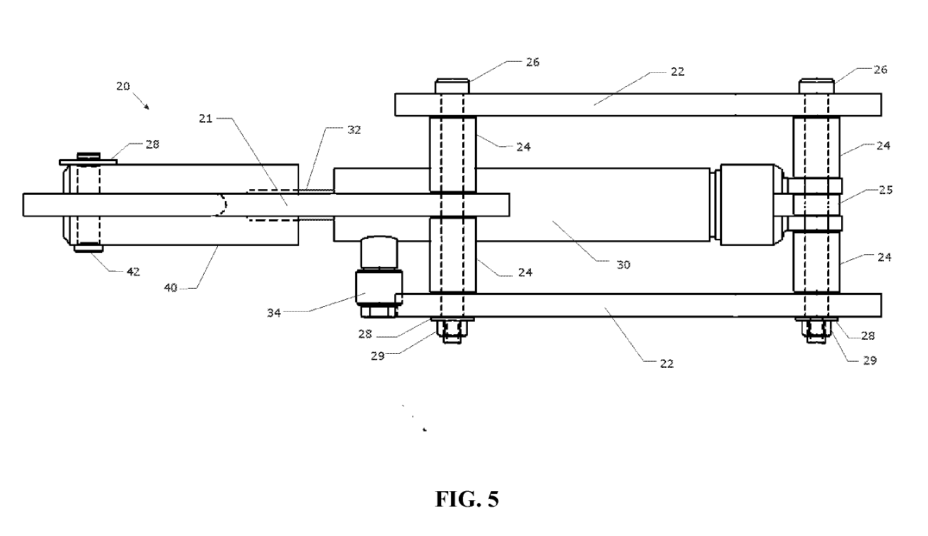

FIG. 5 is a cross section view of the cylinder bracket 40. The cylinder bracket receptor 46 allows the cylinder bracket to connect to the hydraulic cylinder 30.

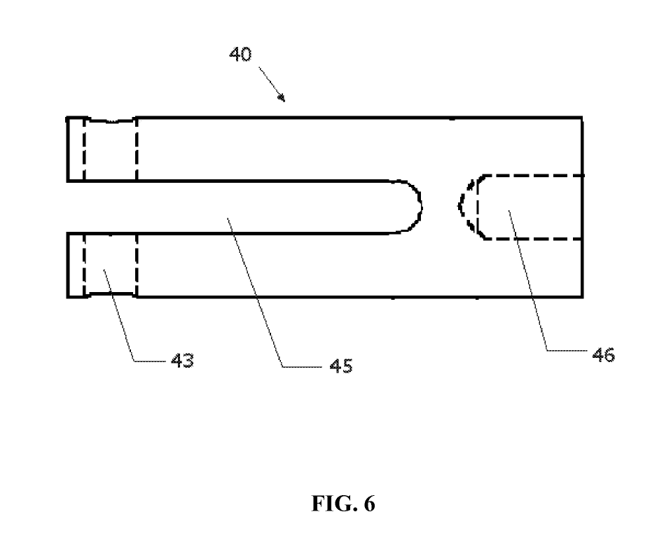

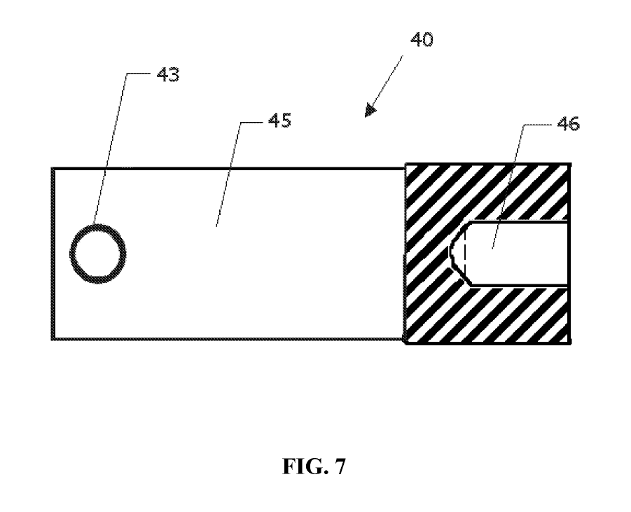

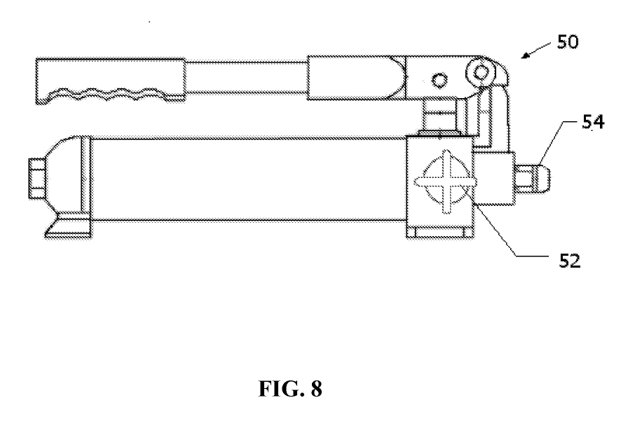

FIG. 6 is a side view of a hand pump 50. The hand pump 50 is connected to the hydraulic cylinder 30 and used to control the action of the hydraulic cylinder 30 to slowly move the clamp arms 21 and 22 together allowing the user to secure the ends of a track 100 over the wheels of a vehicle. The inventors have also used the vehicle to power the clamp arm tool 20, however, using the hand pump 50 to move the hydraulic cylinder 30 is the preferred embodiment. As one of ordinary skill in the art will recognize, the present invention could also be powered by air, mechanical screw or the like, however hydraulic power is the preferred power source.

The use of the clamping arm tool 20 to secure the ends of a track on a skid steer or utility vehicle is as follows. The track 100 should be positioned over the tires of the skid steer or utility vehicle in accordance with the track manufacturer's instructions. As those with skill in the art will understand, typically, a vehicle is driven onto a pair of tracks laying on an even surface. Once the vehicle is substantially centered on the tracks, one track is maneuvered so that the ends of the track are pulled over the outside and over the top of the front and back wheels respectively. This allows the ends of the track to be secured at a position between the front and rear wheels of the vehicle. The two ends of the track must then be drawn together to secure the tracks around the front and back wheels to secure the track as an endless loop around the wheels.

Once the tracks are positioned such that the ends of the track are able to cover the front and rear wheels of the vehicle, the clamping arm tool 20 is placed above the track as shown in FIG. 1. The curved gripping surface 23 is placed over the bars of each end of the track 100. The hand pump 50 is actuated to cause the hydraulic cylinder 30 to pull the cylinder bracket 40 causing the outside clamping arms 22 to close with the middle clamping arm 22. The hand pump 50 allows the ends of the track 100 to be drawn together in a controlled manner until links of the ends of the track are aligned. Once the bolt holes of the ends of the track are properly aligned, the bolts of the track are inserted and secured.

The positioning of the hydraulic cylinder 30 above the curved gripping surfaces 23 allows the majority of the clamping arm tool to be positioned above the working area. With the working area relatively free of obstacles the user is able to install the tracks in a timely manner with greater access to tracks and the installation bolts. Furthermore, the tool provides improved access to the tracks. Improved access to the tracks also allows repairs to be completed with greater ease and allows for removing the tracks from a vehicle easily and quickly.

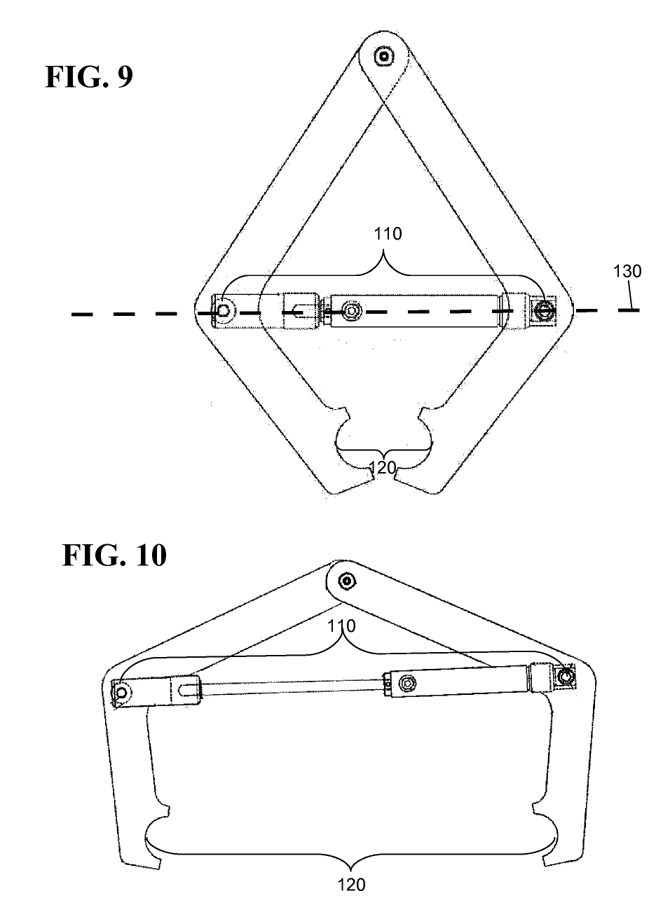

FIGS. 9 and 10 illustrate an example of a clamp arm tool in a fully closed state and a fully open state. In the fully closed state, the fully open states, and all positions in between, the distance between the actuator pivot points 110 or arm pivots is always greater than the distance between the clamping surfaces 120 or gripping surfaces. Also show is the axis of extension 130 of the hydraulic cylinder.

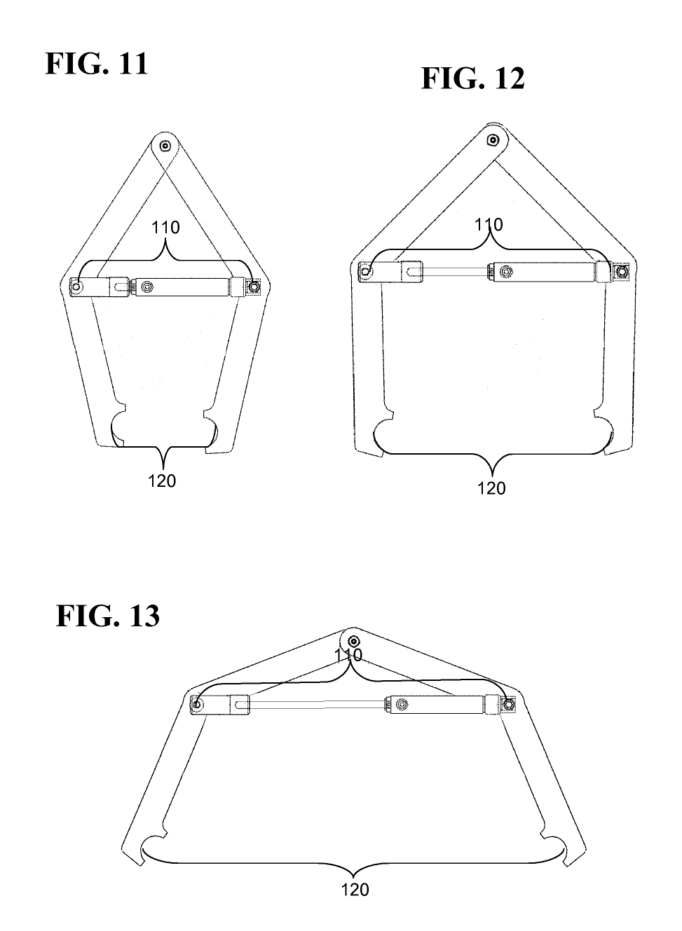

FIGS. 11 through 13 illustrate a second example of a clamp arm tool wherein the fully closed state, the distance between the clamping surfaces 120 is less than the distance between the actuator pivot points 110. In a partially open state shown in FIG. 12, the distance between the clamping surfaces 120 is equal to the distance between the actuator pivot points. In the fully open state shown in FIG. 13. the distance between the clamping surfaces 120 is greater than the distances between the actuator pivot points 110.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A track installation and removal tool comprising:
a plurality of clamping arms connected to a hydraulic cylinder;
each clamping arm having a gripping area to secure opposite ends of a track;
wherein at least a portion of each clamping arm extends beyond either the distal or the proximal end of the hydraulic cylinder along the axis of extension of the hydraulic cylinder.

2. The track installation and removal tool of claim 1 wherein the gripping area of at least one clamping arm does not align with the gripping area of at least one of the remaining clamping arms.

3. The track installation and removal tool of claim 1 wherein each clamping arm rotates within a rotation plane, wherein all of the rotation planes are distinct and parallel.

4. The track installation and removal tool of claim 1 wherein the plurality of clamping arms include a middle clamping arm and two outside clamping arms, the middle clamping arm rotating in a plane located between the rotating planes of each of the outside clamping arms.

5. A method for securing the ends of a track on a utility vehicle comprising the steps of:
positioning a track on a substantially even surface;
placing the vehicle on top of and near the center of the track;
maneuvering the free and opposite ends of the track around the front and rear wheels;
securing the track utilizing a tool comprising:
a first arm rotatably secured to a second arm at an arm pivot;
the first arm having a first gripping area adapted to pull on the tread track;
the second arm having a second gripping area adapted to pull on the tread track;
a hydraulic actuator rotatably secured to the first arm at a first actuator pivot;
the hydraulic actuator rotatably secured to the second arm at a second actuator pivot;
wherein the first actuator pivot is located between the first gripping area and the arm pivot, and the second actuator pivot is located between the second gripping area and the arm pivot.

6. A clamping arm tool for installing a tread track onto a wheeled vehicle, the clamping arm tool comprising:
a first arm rotatably secured to a second arm at an arm pivot;
the first arm having a first gripping area adapted to pull on the tread track;
the second arm having a second gripping area adapted to pull on the tread track;
an actuator rotatably secured to the first arm at a first actuator pivot;
the actuator rotatably secured to the second arm at a second actuator pivot;
wherein the first actuator pivot is located between the first gripping area and the arm pivot, and the second actuator pivot is located between the second gripping area and the arm pivot.

7. The clamping arm tool of claim 6 further comprising:
a third arm rotatably secured to a second arm at the arm pivot;
the actuator rotatably secured to the third arm at the first pivot;
wherein the first arm and the third arm are rotationally locked about the second arm.

8. The clamping arm tool of claim 7 wherein
a portion of the actuator is located between the first arm and the third arm.

9. The clamping arm tool of claim 6 wherein
the first arm second arms are V-shaped; and
the first actuator pivot is located at the apex of the first arm, and the second actuator pivot is located at the apex of the second arm.

10. The clamping arm tool of claim 6 wherein
the actuator actuates from a first state through a second state to a third state;
wherein
in the first state
the separation of the first gripping area from the second gripping area is less than
the separation of the first actuator pivot from the second actuator pivot;
in the second state
the separation of the first gripping area from the second gripping area is equal to
the separation of the first actuator pivot from the second actuator pivot; and
in the third state
the separation of the first gripping area from the second gripping area is more than
the separation of the first actuator pivot from the second actuator pivot.

11. The clamping arm tool of claim 10 wherein
the separation of the first gripping area from the second gripping area is greater in the third state than the second state;
the separation of the first gripping area from the second gripping area is greater in the second state than the first state;
the separation of the first actuator pivot from the second actuator pivot is greater in the third state than the second state;
the separation of the first actuator pivot from the second actuator pivot is greater in the second state than the first state;

12. The clamping arm tool of claim 6, wherein
the separation of the first gripping area from the second gripping area is always less than the separation of the first actuator pivot from the second actuator pivot.

13. The clamping arm tool of claim 12, wherein
the actuator is a hydraulic cylinder.
